(19) United States
(12) Patent Application Publication
(10) Pub. No.: US 2018/0065887 A1
(43) Pub. Date: Mar. 8, 2018

(54) High Quality Calcium Hydroxide Slurries

(71) Applicant: Lhoist North America, Inc., Fort Worth, TX (US)

(72) Inventors: Kevin D. Ingram, Fort Worth, TX (US); Deborah Ballard, Fort Worth, TX (US); Lacey N. Kucerak, Irving, TX (US)

(73) Assignee: Lhoist North America, Inc., Fort Worth, TX (US)

(21) Appl. No.: 15/684,444

(22) Filed: Aug. 23, 2017

Related U.S. Application Data
(60) Provisional application No. 62/383,811, filed on Sep. 6, 2016.

(51) Int. Cl. C04B 2/02; C01F 11/02; C09K 15/06; C02F 5/06

(52) U.S. Cl. CPC C04B 2/02; C02F 5/06; C09K 15/06; C01F 11/02

(57) ABSTRACT

A calcium hydroxide slurry is formed by combining a polymer additive with lime and water to form an aqueous slurry. The slurry so produced is viscostable, resists hard packing even after prolonged storage, is easily redispersed and has antiscaling properties. The amount of lime used is between 35 to 55% by weight of the slurry. The polymer additive is a polycarboxylate dispersing agent and is added in an amount between about 0.1 to 3% by weight of lime.

### CROSS REFERENCE TO RELATED APPLICATIONS

The present application claims priority from a provisional application, Ser. No. 62/383,811, filed Sep. 6, 2016, entitled “High Quality Calcium Hydroxide Slurries”, by the same inventors.

### BACKGROUND OF THE INVENTION

### 1. Field of the Invention

The present invention relates generally to the preparation of stable high quality calcium hydroxide slurries with anti-scaling properties which are useful in applications such as pH control, acid neutralization and reducing calcium hardness.

### 3. Description of the Prior Art

Alkaline products which are used in adjusting pH in commercial activities, such as the treatment of sewage or wastewater, have typically employed sodium hydroxide solutions (commonly referred to as caustic) or suspensions of magnesium hydroxide. Sodium hydroxide is widely available commercially as typically found in a solution having an activity of approximately 50%. As a true solution, 50% caustic is indefinitely stable and has a relatively low viscosity. Magnesium hydroxide is not a solution but rather a suspension of small particles in water. Magnesium hydroxide, however, is not indefinitely stable without agitation, and the particles eventually settle out of suspension forming a sediment layer.

Both caustic and magnesium hydroxide have inherent disadvantages. A 50% strength caustic solution can be dangerous to handle and can result in serious chemical burns if appropriate safety precautions are not followed. Further, magnesium hydroxide reacts much more slowly than sodium hydroxide so that an excess amount of magnesium hydroxide must be typically added to produce adequate reaction rates.

Lime has a relatively rapid reaction rate and is fairly safe to handle, making it preferable to use in place of caustic soda or magnesium hydroxide. Further, lime is generally less costly than caustic or magnesium hydroxide. To make a conventional lime slurry, either hydrated lime, Ca(OH)₂, or quicklime, CaO, can be added to water. In many instances, Ca(OH)₂ is preferred, due to handling considerations.

Several disadvantages, however, prevent conventional lime slurries from being used where caustic soda solutions would otherwise be used. Because lime slurries are composed of individual calcium hydroxide particles, these calcium hydroxide particles will tend to settle from suspension. Further, the viscosity of conventional lime slurry is high compared to caustic soda. It is difficult to produce a conventional lime slurry with a solids content of greater than about 32% without producing such a high viscosity that the material becomes unmanageable. Typically, a viscosity above approximately 2000 cps can cause handling difficulties. Lime slurry can be made less viscous by the addition of gypsum during slaking. Solids content in excess of 40% can be produced in this way. However, the effect of the gypsum is to agglomerate the lime making an abundance of large calcium hydroxide particles. These large lime particles quickly settle from suspension and form a hard sediment that is hard to remove and causes plugging of pipes. In addition, large lime particles react more slowly and display other detrimental characteristics.

Another method to moderate the viscosity of a high-solids content hydrated lime suspension may be to incorporate a polymeric dispersing agent. For example, certain polyacrylics, polycarboxylic acids and alkali metal salts thereof have been used as dispersing agents to moderate the viscosity of such a high-solids suspension. See, for example, U.S. Pat. No. 5,616,283, to Huege, et al. In some circumstances, high amounts of dispersants have been necessary to achieve high solids content lime slurries with low viscosities. High amounts of dispersants are undesirable in many applications. For instance, neutralized waste water is commonly treated in an aeration basin. Excess dispersant can cause foam to accumulate on the aerated waste resulting in significant processing difficulties. Also, polymeric dispersants add to the total organic content of material treated which can be undesirable. Further, high dispersant amounts would add considerably to the cost of producing lime slurries for use as a caustic replacement. It is therefore necessary to reduce or minimize the amount of dispersants, especially the polymeric dispersants in formulating a low viscosity of lime slurries for a caustic replacement.

Another problem with creating lime slurries, especially a high solids slurry, is that such slurries can cause scaling with the equipment being used. For example, the increase in solids can result in very high viscosities and can also lead to increased scaling in the slurry-producing, storage, conveying and dosing equipment as well as in other areas within the process afterwards. For example, this scaling can occur within any areas the slurry has been subsequently introduced. The scaling can lead to maintenance issues, feed rate decrease, density changes and, in addition, scaling may also increase lime usage.

Therefore, it is desirable to develop the process in which scaling may be reduced in the production of a lime slurry in order to reduce these issues associated with scaling described herein.

Further, it is an object of this invention to produce a lime slurry having a high solids content of more than about 35% by weight and a viscosity of less than 2000 cps, and preferably less than 1000 cps.

It is another object of this invention to provide a lime slurry that remains stable for several days without settling into a hard packed sediment that cannot be easily re-suspended.

It is yet another object of this invention to provide a lime slurry that is of low viscosity and high solids content with little dispersing agent.

Additional objects, features and advantages will be apparent in the written description which follows.

### SUMMARY OF THE INVENTION

The present invention yields a calcium hydroxide slurry that is visco stable, resists hard packing even after prolonged storage; is easily redispersed, and has antiscaling properties.

The calcium hydroxide slurries of the invention are formed by mixing together lime and a polymer additive in water to form an aqueous slurry. The amount of lime used is generally between about 35-55% by weight of the slurry. The polymer additive may be a polycarboxylate dispersing agent which is preferably used in an amount of less than 3% by weight based on the weight of lime. Preferably, between 0.1 to 2% by weight of lime are used, and more preferably 0.5 to 1.0% of polymer additive is used based on the dry weight of lime. The lime slurry formulated in the described manner can be used, for example, as a caustic replacement for sodium hydroxide in a generally 1:1 ratio.

The manufacturing process is not complicated. The slurries of the invention can be manufactured by using the three elements previously described: water (potable, recycled, DI, or “dirty”—i.e. bayou water), the polymer additive, and lime hydrate. The polymer additive can be added to the water, mixed, then the hydrate added or the polymer additive can be added after the water and hydrate have been mixed. Vigorous mixing is necessary to properly disperse the polymer additive. One preferred class of polymer additive is manufactured commercially by SNF Floerger, One Chemical Plant Road, Riceboro, Ga., as the FLOSPERSE™ line of polymeric dispersants.

The resulting product is a hydrated lime slurry with an anti-scaling properties. The polymer additive allows the slurry to have a higher-solid content (up to about 45-55%-solids) while maintaining a low viscosity (<1000 cP, measured throughout using a RV spindle at 100 rpm). The viscosity remains stable over time with static and dynamic mixing. The polymer additive promotes an anti-scaling effect for calcium carbonate and calcium sulfate scale. Lastly, the polymer additive does not affect slurry characterization properties including available lime, consumption/utilization of the slurry, and reactivity.

These and other features, aspects, and advantages of the present invention will become better understood with reference to the following description and appended claims.

### BRIEF DESCRIPTION OF THE DRAWINGS

FIG. 1 is a graph of viscosity versus elapsed time for various concentrations of polymer additive in lime slurries and also illustrating the effects of various concentrations of polymer additive versus static viscosity over time.

FIG. 2 is a graph of percent scale inhibition versus dosing rate for lime slurries dosed with the polymer additive of the invention.

### DETAILED DESCRIPTION OF THE INVENTION

As described in the Background portion of the application, fluid calcium hydroxide slurries prepared in a conventional manner from quicklime and water, or from simple mixing of calcium hydroxide with water, will increase in viscosity over time, will settle and can be difficult to redisperse after storage or transport. Additionally calcium hydroxide slurries can form scale in pipes, tanks and other storage and handling equipment.

To produce the desired stable, high solids lime slurry it is necessary to provide a low viscosity so that the slurry can be easily pumped. Slurries having a viscosity of less than 2000 cps and preferably less than 1000 cps as measured at 100 RPM on a Brookfield™ or Labline™ viscometer are generally required to be usable as a replacement for caustic solutions. A pumpable lime slurry with high solids content is formulated by first adding a polymer additive to the initial slurry water and then adding the required amount of lime. Alternatively, the polymer additive can be added after the water and hydrated lime are mixed.

The preferred polymer additives are formatives of polymethacrylic acid along with the alkali metal salts thereof. The most preferred polymer additives which are used are polycarboxylates, and the alkali metal salts thereof. A commercially available polycarboxylate dispersing agent is available as the FLOSPERSE™ line of polymeric dispersants manufactured commercially by SNF Floerger, One Chemical Plant Road, Riceboro, Ga. These polycarboxylates are described by the manufacturer as being (Meth) Acrylate homo and copolymers, i.e., either a homopolymer or a copolymer of (meth) acrylic acid with a number of different co-monomers, the general structure is depicted below:

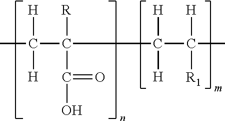

### R=H, CH₃

R₁=special functional group of a co-monomer such as a sulfonate monomer
m=0 for homopolymer of acrylic acid or methacrylic acid

The carboxylic acid group in the polymer backbone may be neutralized with sodium, potassium, or ammonium hydroxides to give the corresponding salts.

The FLOSPERSE™ dispersant product line contains both homopolymers as well as specialty copolymers of different compositions and various levels of molecular weights (2,000 to 100,000). The properties of these specialty copolymers can be engineered by properly selecting the monomers and their relative compositions and through choice and control of the polymerization process. The preferred polymer additives for purposes of the invention have molecular weights under about 10,000 Daltons, more preferably between about 2,000 and 10,000. A particularly preferred FLOSPERSE™ dispersing agent is the FLOSPERSE™ 3000.

The preferred polymer additives are pH stable at 12.44 pH (the normal pH of lime) and above and are heat stable at normal operating conditions at which the slurry is being used. Since the slurries of the invention can be mad using hydrated lime as the lime source, heat of hydration is not a significant factor as it would be in the case of using quicklime as the lime starting material.

Preferred particle sizes for the lime hydrate used in the slurries of the invention have a d₅₀ mean particle size of less than about 10 μm. The notation d_{X} represents a diameter expressed in μm, as measured by laser granulometry in methanol optionally after sonication, relatively to which X % by mass of the measured particles are smaller or equal.

As mentioned, the polymeric dispersing agents are preferably used in amount of less than 3% by weight based on the weight of lime. Preferably, between 0.1 to 2% by weight of lime are used, and more preferably 0.5 to 1% of dispersing agent is used based on the dry weight of lime.

The lime used in forming these slurries may be either hydrated lime or quicklime. Hydrated lime is preferable due to its safety and ease of handling. The hydrated lime can simply be added to water to form a hydrated lime slurry. A slurry having, for example, approximately 40% solids by weight of slurry is acceptable for purposes of the present invention, although the solids content of the slurry may vary, depending upon the particular application at hand.

The following examples illustrate the effects of the addition of the preferred polymeric dispersing agents on the resulting slurry properties of interest, such as the effect on the slurry viscosity. The examples were prepared and analyzed as described in the protocol which follows:

### I. Polymer Information:

The polymer additive used in the following hydrate slurry formulations is called Flosperse™, made by SNF. The preferred formulations described utilize Flosperse™ 3000, but other Flosperse™ equivalent polymers and related product lines may also be utilized in some applications. As has been described, the Flosperse™ products are water-soluble polycarboxylate acrylates containing both homopolymers and copolymers with a number of different co-monomers. Commercially available molecular weights range from 2,000 to 100,000, while the most preferred molecular weight ranges are below about 10,000, most preferably between about 2,000 and 10,000.

### II. Viscosity Data Examples

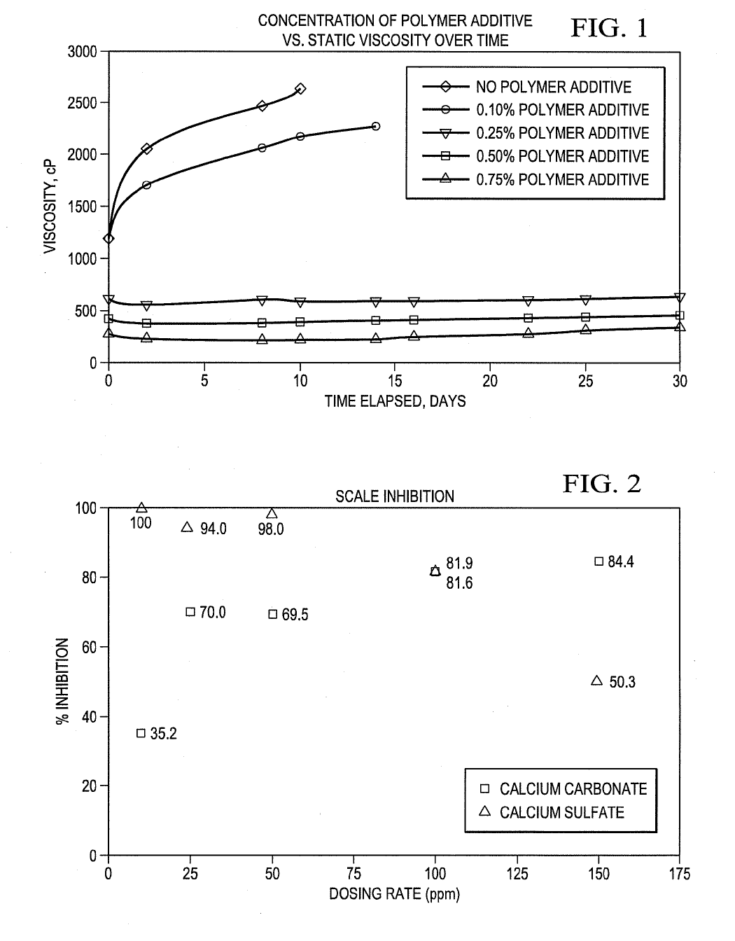

Note: all concentrations are based off of active ingredients and calculated on a dry weight/weight basis.
Table 1 and FIG. 1 of the Drawings compare the static viscosity of slurries with varying additions of polymer additive.
Table 2 shows the dynamic viscosity of a slurry formulated with the polymer additive over 10 days.
Table 3 compares the difference in static viscosity over time of a slurry that added the polymer additive to the water (then hydrate added) vs. adding the polymer additive to the hydrate-water mix.
Table 4 compares the difference in dynamic viscosity over time of a slurry that added the polymer additive to the water (then hydrate added) vs. adding the polymer additive to the hydrate-water mix.

Table 1 shows the static viscosity of hydrated lime slurry at 40%-solids with additions of the polymer additive of the invention ranging from 0-0.75% wt/wt over a 30 day period. See also, FIG. 1 of the Drawings.

TABLE 1
Percent-solids of hydrate slurry: 40.0%

| | Polymer Additive wt/wt % | | | | |
|---|---|---|---|---|---|
| | 0.00 | 0.10 | 0.25 | 0.50 | 0.75 |
| Time Elapsed (days) | Viscosity, cP | | | | |
| 0 | 1190 | 1196 | 619 | 425 | 281 |
| 2 | 2052 | 1703 | 557 | 377 | 213 |
| 8 | 2468 | 2060 | 607 | 381 | 215 |
| 10 | 2640 | 2176 | 590 | 391 | 221 |
| 14 | >3000 | 2272 | 594 | 406 | 227 |
| 16 | >3000 | >3000 | 595 | 411 | 249 |
| 18 | >3000 | >3000 | | | |
| 22 | >3000 | >3000 | 607 | 430 | 278 |
| 25 | >3000 | >3000 | 617 | 441 | 312 |
| 30 | >3000 | >3000 | 638 | 458 | 340 |

Table 2 shows the dynamic viscosity over 10 days of hydrated lime slurry at 40%-solids with 0.50% wt/wt polymer additive being added over a 10 day period.

TABLE 2
40%-solids slurry with 0.50% wt/wt Polymer Additive

| Time Elapsed (days) | Viscosity, cP |
|---|---|
| 1 | 297 |
| 7 | 297 |
| 9 | 322 |
| 10 | 228 |

Table 3 shows the static viscosity over 29 days of hydrated lime slurry at 40%-solids with 0.50% wt/wt polymer additive added. A comparison was made between adding the polymer additive to the water and adding the polymer additive to the slurry.

TABLE 3
40%-solids slurry with 0.50% wt/wt Polymer Additive
3000 Static Viscosity over a 29 day period, cP

| | Polymer added to water | |
|---|---|---|
| Time Elapsed (days) | (then hydrate added) | Polymer added to slurry |
| 1 | 124 | 122 |
| 7 | 126 | 129 |
| 15 | 138 | 148 |
| 23 | 164 | 181 |
| 29 | 187 | 217 |

Table 4 shows the dynamic viscosity of hydrated lime slurry at 40%-solids with 0.50% wt/wt polymer additive over a 29 day period. A comparison was made between adding the polymer additive to the water and adding the polymer additive to the slurry.

TABLE 4
40%-solids slurry with 0.50% wt/wt Polymer Additive
3000 Dynamic Viscosity over a 29 day period, cP

| | Polymer added to water | |
|---|---|---|
| Time Elapsed (days) | (then hydrate added) | Polymer added to slurry |
| 1 | 137 | 116 |
| 7 | 126 | 123 |
| 15 | 169 | 220 |
| 23 | 256 | 310 |
| 29 | 486 | 392 |

### III. Anti-Scaling Effect

FIG. 2 of the Drawings is a graph showing the results of a laboratory scale test method that determines comparative scaling inhibition effectiveness of slurries made with the polymer additive of the invention with the polymer additive being added in amounts from 10-150 ppm. Results are applicative for ranking anti-scaling additives for scale inhibition purposes. Note that all concentrations are based off of active ingredients and calculated on a dry weight/weight basis.

An invention has been provided with several advantages:

1. The polymer additives used in the slurries of the invention stabilize viscosity when added to the water and when added to the hydrate slurry. In both static and dynamic mixing over 1 month, the slurry did not exceed 1,000 cP when created at a high percent-solids (greater than 35%-solids). The initial viscosity ranges between 100-200 cP and after one month, the viscosity is <500 cP. In addition, the ease of daily resuspension and lack of hardpack was notable.
2. The polymer additive does not affect the performance of the slurry; the reactivity, available lime, and consumption/utilization does not change when the polymer additive is added to a slurry (or to water then hydrate added). Benchscale testing at customer sites support the fact that performance is unchanged with the polymer additives of the invention, as total hardness, calcium hardness, alkalinity conductivity, turbidity, and pH show similar measurements when doing benchscale jar testing compared against a regular hydrate slurry.
3. Observations show that slurries containing the polymer additives of the invention “slick off/bead off” the sides of containers versus the normal white coating of lime slurry left behind by slurries not containing the polymer additive of the invention.
4. Scale testing demonstrates the anti-scaling effect of the polymer additives of the invention, with up to 100% of calcium sulfate scale inhibited and up to 85% calcium carbonate scale inhibited, using 10-150 ppm of the polymer additive of the invention.

While the invention has been shown in only one of its forms, it is not thus limited but is susceptible to various changes and modifications without departing from the spirit thereof.

What is claimed is:

1. A lime slurry composition having anti-scaling properties, the slurry composition comprising:
water;
lime in an amount between about 35 to 55% by weight;
a polymer additive in an amount of between 0.1 to 3% by weight of the lime; and
wherein the polymer additive is a polycarboxylate dispersing agent, the polymer additive having a molecular weight below 10,000, and also being pH stable at pH 12.44 and above, and wherein the lime used in forming the slurry composition has a mean particle size d₅₀ of less than 10 μm.

2. The lime slurry composition of claim 1, wherein the polymer additive is either a homopolymer or a copolymer of (meth) acrylic acid having at least one carboxylic acid group and wherein the carboxylic acid group may be neutralized with sodium, potassium, or ammonium hydroxide to give the corresponding salt.

3. The lime slurry composition of claim 2, wherein the polymer additive has a molecular weight of approximately 3,000 Daltons.

4. A method of forming a lime slurry adapted for use as an alkaline neutralizing agent and having anti-scaling properties, the method comprising the steps of:
mixing lime and a polymer additive in water to form an aqueous slurry, the amount of lime being between about 35 to 55% by weight of the slurry and the amount of the polymer additive being between about 0.1 to 3% by weight of the lime;
wherein the polymer additive is a polycarboxylate dispersing agent having a molecular weight below 10,000, and also being pH stable at pH 12.44 and above, and wherein the lime used in forming the slurry composition has a mean particle size d₅₀ of less than 10 μm.

5. The method of claim 4, wherein the polymer additive is either a homopolymer or a copolymer of (meth) acrylic acid having at least one carboxylic acid group and wherein the carboxylic acid group may be neutralized with sodium, potassium, or ammonium hydroxide to give the corresponding salt.

6. The method of claim 5, wherein the polymer additive has a molecular weight of approximately 3,000 Daltons.

7. The method of claim 4, wherein the polymer additive is added to the water prior to adding the lime.

8. The method of claim 4, wherein the lime and polymer additive are added to the water at approximately the same time.

9. The method of claim 4, wherein the polymer additive is added to the previously formed water and lime slurry.

10. A method of forming a pumpable lime slurry having a viscosity of less than 1000 cP, measured using a RV spindle at 100 rpm, having anti-scaling properties, the method comprising the steps of:
mixing hydrated lime and a polymer additive in water to form an aqueous slurry, the amount of lime being between about 35 to 55% by weight of the slurry and the amount of the polymer additive being between about 0.1 to 3% by weight of the lime;
wherein the polymer additive is a polycarboxylate dispersant having a molecular weight below 10,000, and also being pH stable at pH 12.44 and above, and wherein the lime used in forming the slurry composition has a mean particle size d₅₀ of less than 10 μm.

11. The method of claim 10, wherein the polymer additive is either a homopolymer or a copolymer of (meth) acrylic acid having at least one carboxylic acid group and wherein the carboxylic acid group may be neutralized with sodium, potassium, or ammonium hydroxide to give the corresponding salt.

12. The method of claim 11, wherein the polymer additive has a molecular weight of approximately 3,000 Daltons.
